(19) United States
(12) Patent Application Publication
(10) Pub. No.: US 2019/0152271 A1
(43) Pub. Date: May 23, 2019

(54) Pneumatic Tire

(71) Applicant: The Yokohama Rubber Co., LTD., Minato-ku, Tokyo (JP)

(72) Inventor: Takahisa Murata, Hiratsuka-shi, Kanagawa (JP)

(21) Appl. No.: 16/305,850

(22) PCT Filed: May 19, 2017
(86) PCT No.: PCT/JP2017/018887

§ 371 Date: Nov. 29, 2018

(30) Foreign Application Priority Data
May 30, 2016 (JP) 2016-107028

(51) Int. Cl. B60C 11/03

(52) U.S. Cl. CPC B60C 11/0306; B60C 2200/14; B60C 2011/0346

(57) ABSTRACT

A pneumatic tire includes: a circumferential groove in a circumferential direction; and center and shoulder blocks defined by angled inner grooves communicating with the circumferential groove while inclined in one direction with respect to the circumferential direction and by angled outer grooves communicating with the angled inner grooves while inclined in another direction with respect to the circumferential direction, and that includes repetitive elements including the grooves and the blocks, the pitches of the repetitive elements varying in the circumferential direction. The circumferential groove includes widened portions and narrow width portions alternately disposed in the circumferential direction. The angled inner grooves communicate with the widened portions. An inclination angle, formed by an imaginary straight line connecting centers of opening ends of a pair of the angled inner grooves communicating with the widened portion corresponding thereto, with respect to the circumferential direction, decreases as the pitches of the repetitive elements decrease.

### TECHNICAL FIELD

The present technology relates to a pneumatic tire and more particularly relates to a pneumatic tire that makes it possible to achieve enhanced driving performance on muddy road surfaces while maintaining noise performance.

### BACKGROUND ART

Pneumatic tires used for driving in muddy areas, snowy roads, sandy areas, and the like (hereinafter collectively referred to as “muddy areas and the like”) have typically tread patterns mainly composed of lug grooves and blocks having many edge components, and having large groove areas. Such tires catch mud, snow, sand, and the like (hereinafter collectively referred to as “mud and the like”) on road surfaces to obtain traction performance and, at the same time, prevent mud and the like from clogging in the grooves (performance improvement in discharging mud and the like) so that driving performance in muddy areas and the like (mud performance) is enhanced. However, such patterns are mainly composed of blocks, and thus easily cause pattern noise. In addition, since the lug grooves are main components, the thus-generated noise is easily emitted to the outside of the vehicle through the lug grooves. Thus, it has been difficult to maintain sufficient noise performance.

To solve such problems, Japan Unexamined Patent Publication No. 2012-056464, for example, proposes changing the pitches of blocks to prevent the generation of pattern noise and increasing the inclination of the lug grooves with respect to the circumferential direction in accordance with a decrease in the length of pitches of the blocks in order to reduce differences in rigidity between the blocks having small pitches and the blocks having large pitches and thus to maintain driving performance. However, such patterns still do not always provide sufficiently satisfactory mud performance and noise performance in a compatible manner, hence, further improvements are required.

### SUMMARY

The present technology provides a pneumatic tire that makes it possible to achieve enhanced driving performance on muddy road surfaces while maintaining noise performance.

A pneumatic tire according to the present technology is provided with a circumferential groove extending in a tire circumferential direction in a center region of a tread portion, a plurality of angled inner grooves disposed on either side of the circumferential groove and communicating with the circumferential groove while being inclined in one direction with respect to the tire circumferential direction, a plurality of angled outer grooves disposed on either side of the circumferential groove and communicating with the angled inner grooves while being inclined in another direction with respect to the tire circumferential direction, center blocks defined by the grooves at positions adjacent to the circumferential groove, and shoulder blocks defined by the grooves between the angled outer grooves adjacent to each other in the tire circumferential direction, the pneumatic tire being further provided with a plurality of repetitive elements including the grooves and the blocks and repeatedly disposed in the tire circumferential direction, the repetitive elements including a plurality of repetitive elements of a plurality of types having different pitches. The circumferential groove includes a plurality of widened portions and a plurality of narrow width portions alternately disposed in the tire circumferential direction and thus has a groove width varying in the tire circumferential direction. The angled inner grooves communicate with the widened portions. An inclination angle θ, formed by an imaginary straight line connecting centers of opening ends of a pair of the angled inner grooves open to and communicating with the widened portion corresponding thereto, with respect to the tire circumferential direction, varies for each widened portion and decreases as the pitches of the repetitive elements decrease.

In the present technology, the pitches of the repetitive elements vary in the tire circumferential direction as described above. This causes the frequencies of hitting sound, produced when the blocks hit a road surface, to be dispersed, resulting in reduction in the pattern noise. Meanwhile, since the angled inner grooves and the angled outer grooves, which are combined as described above, constitute a tread pattern, fluctuations in ground reaction force are reduced over the entire tread, leading to an improvement in the driving performance. In addition to this, the widened portions with relatively wide groove widths included in the circumferential groove catch mud and the like sufficiently. This improves the traction characteristics, and thus improves the mud performance. Here, making the angled inner grooves communicate with the widened portions advantageously improves mud discharge capability to improve the mud performance. In addition, the grooves in the center region of the repetitive elements having smaller pitches are easily clogged with mud and the like. However, the inclination angle θ of the imaginary straight line is set to be reduced as the pitches of the repetitive elements decrease. This facilitates the discharge of the mud and the like clogged inside the grooves, and thus effectively improves the mud performance. In the present technology, a minimum value θmin of the inclination angle is preferably from 10° to 50°, a maximum value θmax of the inclination angle is preferably from 40° to 120°, and a difference Δθ between the minimum value θmin and the maximum value θmax is preferably from 30° to 90°. Setting the inclination angle as described above facilitates the flows of mud and the like inside the grooves and results in improving the mud performance while enabling the noise to be effectively dispersed to improve the noise performance. Consequently, these performances are advantageously provided in a compatible manner.

In the present technology, the repetitive elements disposed on one side of the circumferential groove and the repetitive elements disposed on the other side of the circumferential groove are preferably disposed such that the pitches of the repetitive elements are shifted from each other. This effectively reduces the fluctuations in ground reaction force to improve the driving performance and, at the same time, effectively disperses the noise to improve the noise performance.

In the present technology, the widened portions preferably have a substantially quadrangular shape including a pair of opposite angles protruding to both sides in a tire lateral direction, and the angled inner grooves preferably communicate with the widened portions at parts around the opposite angles. As described above, making the angled inner grooves communicate with the parts around the opposite angles of the widened portions, at which mud and the like flowing in the circumferential groove are easily concentrated, facilitates discharge of the mud and the like inside the circumferential groove through the angled inner grooves. This advantageously improves the mud discharge capability.

### BRIEF DESCRIPTION OF DRAWINGS

FIG. 1 is a meridian cross-sectional view of a pneumatic tire according to an embodiment of the present technology.

FIG. 2 is a front view illustrating a tread surface of the pneumatic tire according to the embodiment of the present technology.

FIG. 3 is an enlarged view of a main portion for illustrating the inclination angles of imaginary straight lines.

FIG. 4 is an enlarged view of the main portion for illustrating the shape of widened portions.

### DETAILED DESCRIPTION

Configuration of embodiments of the present technology is described in detail below with reference to the accompanying drawings.

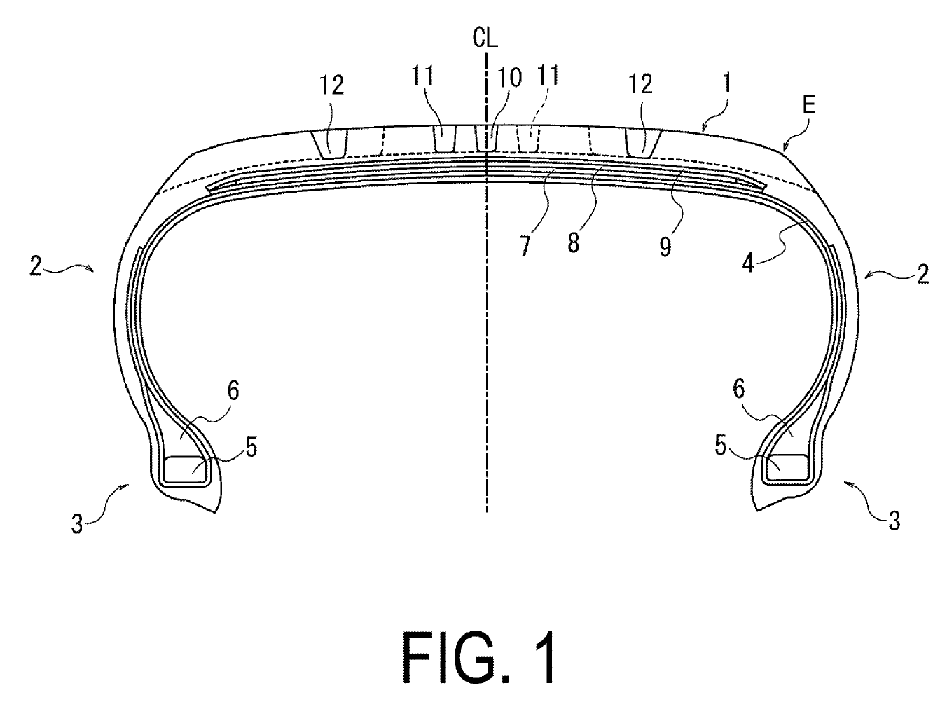

As illustrated in FIG. 1, the pneumatic tire of the present technology includes a tread portion 1 with an annular shape extending in the tire circumferential direction, a pair of sidewall portions 2 disposed on both sides of the tread portion 1, and a pair of bead portions 3 disposed inward of the sidewall portions 2 in the tire radial direction. Reference sign CL in FIG. 1 denotes the tire equator, and reference sign E denotes a ground contact edge.

A carcass layer 4 is mounted between the left and right pair of bead portions 3. The carcass layer 4 includes a plurality of reinforcing cords extending in the tire radial direction, and is folded back around a bead core 5, which is disposed in each of the bead portions 3, from a vehicle inner side to a vehicle outer side. Additionally, bead fillers 6 are disposed on the peripheries of the bead cores 5, and each bead filler 6 is enveloped by a body portion and a folded back portion of the carcass layer 4. In the tread portion 1, a plurality of belt layers 7 (two layers in FIG. 1) are embedded on the outer circumferential side of the carcass layer 4. The belt layers 7 each include a plurality of reinforcing cords that are inclined with respect to the tire circumferential direction, the directions of the reinforcing cords of the different layers crossing each other. In these belt layers 7, the inclination angle of the reinforcing cords with respect to the tire circumferential direction is set in the range, for example, of 10° to 40°. In addition, a belt reinforcing layer 8 is provided on the outer circumferential side of the belt layers 7. The belt reinforcing layer 8 includes organic fiber cords oriented in the tire circumferential direction. In the belt reinforcing layer 8, the angle of the organic fiber cords with respect to the tire circumferential direction is set, for example, to from 0° to 5°.

The present technology may be applied to such a typical pneumatic tire, however, the cross-sectional structure thereof is not limited to the basic structure described above.

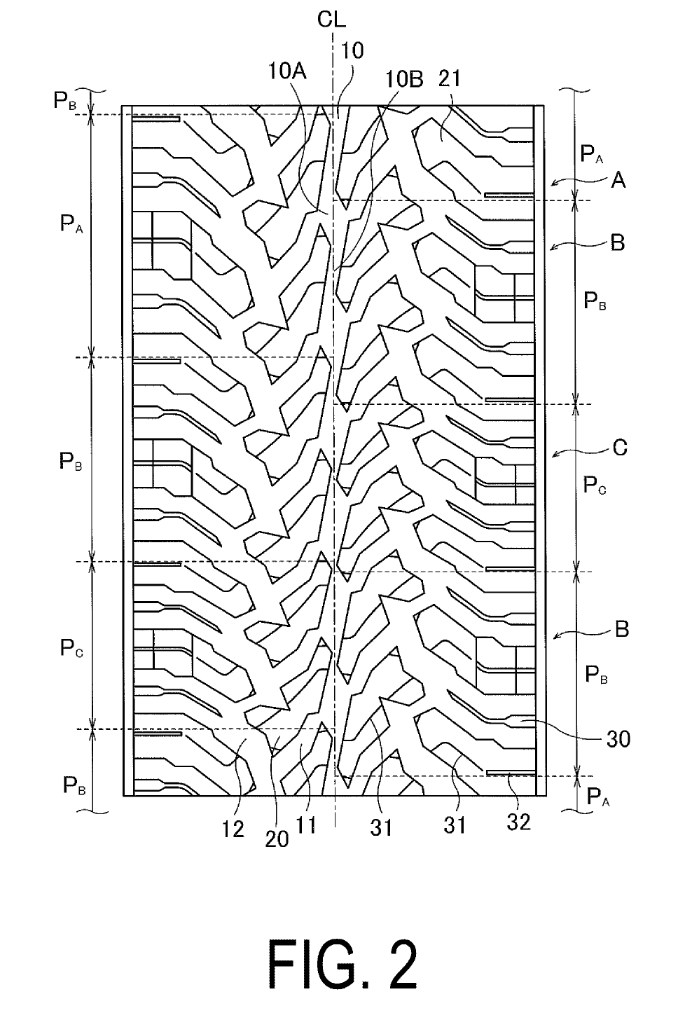

As illustrated in FIG. 2, a circumferential groove 10 extends in the tire circumferential direction in a center region (on the tire equator CL in the drawings) of the tread portion 1. Additionally, a plurality of angled inner grooves 11 and a plurality of angled outer grooves 12 are formed on either side of the circumferential groove 10 at intervals in the tire circumferential direction. The circumferential groove 10, the angled inner grooves 11, and the angled outer grooves 12 define center blocks 20 and shoulder blocks 21.

The circumferential groove 10 has a structure including a plurality of widened portions 10A and a plurality of narrow width portions 10B alternately disposed, and thus has a groove width varying in the tire circumferential direction. In particular, in the example illustrated in FIG. 2, the widened portions 10A and the narrow width portions 10B that are alternately disposed cause the circumferential groove 10 to exhibit a zigzag shape extending in the tire circumferential direction. Portions (corresponding to the widened portions 10A) inclined in one direction with respect to the tire circumferential direction each have a relatively wide width, and portions (corresponding to the narrow width portions 10B) inclined in another direction with respect to the tire circumferential direction each have a relatively a small width.

The angled inner grooves 11 each extend in one direction with inclination with respect to the tire circumferential direction. First ends (inner end portions in the tire lateral direction) of the angled inner grooves 11 communicate with the respective widened portions 10A of the circumferential groove 10, and second ends (outer end portions in the tire lateral direction) of the angled inner grooves 11 communicate with the respective angled outer grooves 12 described below. In the example illustrated in FIG. 2, the angled inner grooves 11 inclined in the one direction with respect to the tire circumferential direction are each bent at an intermediate point thereof to change an inclination angle.

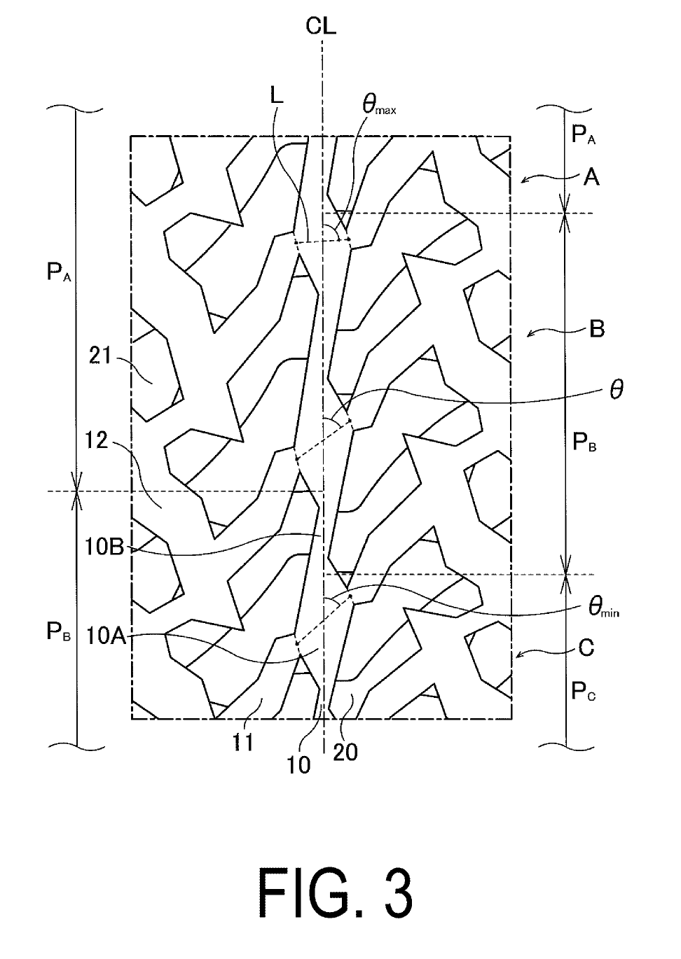

In the present technology, the angled inner grooves 11 are formed on either side of the circumferential groove 10, and thus a pair of angled inner grooves 11 communicate with one widened portion 10A corresponding thereto. As illustrated in FIG. 3, when a straight line connecting the centers of opening ends of the pair of angled inner grooves 11 open to and communicating with the corresponding widened portion 10A is defined as an imaginary straight line L, an inclination angle θ formed by the imaginary straight line L with respect to the tire circumferential direction varies for each widened portion 10A and decreases as the pitches of repetitive elements decrease.

The angled outer grooves 12 each extend in the other direction (direction opposite the inclination direction of the angled inner grooves 11) with inclination with respect to the tire circumferential direction. First ends (inner end portions in the tire lateral direction) of the angled outer grooves 12 communicate with the respective angled inner grooves 11, and second ends (outer end portions in the tire lateral direction) of the angled outer grooves 12 are open outward in the tire lateral direction. In the example illustrated in FIG. 2, the angled outer grooves 12 cross the angled inner grooves 11, and the first ends terminate within the respective center blocks 20 described below. Additionally, in the example illustrated in FIG. 2, the angled outer grooves 12 inclined in the other direction with respect to the tire circumferential direction are each bent at an intermediate point thereof to change the inclination angle. Furthermore, in the example illustrated in FIG. 2, the angled outer grooves 12 each include a projection portion 30 protruding from the middle of a groove bottom adjacent to the second end and extending along the angled outer groove 12.

The center blocks 20 are defined by the circumferential groove 10, the angled inner grooves 11, and the angled outer grooves 12, and are located adjacent to the circumferential groove 10. As described above, the first ends of the angled outer grooves 12 terminate within the respective center blocks 20, and thus it appears as though the center blocks 20 each have a substantially triangular notch in the example illustrated in FIG. 2. Each center block 20 is provided with a sipe 31 that has a first end communicating with the circumferential groove 10, bent within the center block 20 and then extending in the direction, along which the angled inner grooves 11 extend, to cross the first end (notch) of one angled outer groove 12, and that has a second end communicating with another angled outer groove 12. Acute angle portions in contact with the circumferential groove 10 and the angled inner grooves 11 and acute angle portions in contact with the angled inner grooves 11 and the angled outer grooves 12 are chamfered. The shoulder blocks 21 are defined by the angled outer grooves 12 and the angled inner grooves 11, and are each located between two angled outer grooves 12 adjacent to each other in the tire circumferential direction. Each shoulder block 21 is provided with the sipe 31 and a narrow groove 32. The sipe 31 communicates, at the first end, with one angled outer groove 12, is bent within the shoulder block 21 and then extends in the direction, along which the angled outer grooves 12 extend, and, at the second end, terminates within the shoulder block 21. The narrow groove 32 extends from the terminating end portion of the sipe 31 in the direction along which the angled outer grooves 12 extend. The sipe 31 and the narrow groove 32 are not continuous, that is, are separate from each other. A corner portion in contact with the angled outer groove 12 and the angled inner groove 11 corresponding thereto is chamfered.

The tread pattern according to the present technology is configured of a plurality of repetitive elements including the circumferential groove 10, the angled inner grooves 11, the angled outer grooves 12, the center blocks 20, and the shoulder blocks 21 (the sipes 31 and the narrow grooves 32 may also be included discretionary as illustrated), which are repeatedly disposed in the tire circumferential direction. Here, the plurality of repetitive elements have different pitches. For example, the example illustrated in FIG. 2 includes three types of repetitive elements A, B, and C with the pitches P_{A}, P_{B}, and P_{C}, respectively, where the size relationship P_{A}>P_{B}>P_{C} is satisfied. The grooves and the blocks in each repetitive element are components identical to one another. Thus, the grooves and the blocks in the repetitive elements having larger pitches are expanded in the tire circumferential direction, and the grooves and the blocks in the repetitive elements having smaller pitches are compressed in the tire circumferential direction.

In the tread pattern according to the present technology having the above-described configuration, the pitches of the repetitive elements vary in the tire circumferential direction, and thus the sizes of the series of blocks disposed in the tire circumferential direction are not constant. This causes the frequencies of hitting sound, produced when the blocks hit the road surface, to be dispersed, resulting in a reduction in the pattern noise. Meanwhile, since the angled inner grooves 11 and the angled outer grooves 12 combined as described above constitute the basic design of the tread pattern, fluctuations in ground reaction force are reduced over the entire tread, leading to an improvement in the driving performance. In addition to this, the widened portions 10A with relatively wide groove widths included in the circumferential groove 10 make it possible to catch mud and the like sufficiently. This improves the traction characteristics, and thus improves the mud performance. Here, making the angled inner grooves 11 communicate with the widened portions 10A enables the mud and the like inside the circumferential groove 10 to be discharged to the vehicle outer side through the angled inner grooves 11. This advantageously improves mud discharge capability, thereby improving the mud performance. In addition, the grooves in the center region of the repetitive elements having smaller pitches are easily clogged with the mud and the like. However, the inclination angle θ of the imaginary straight line is set to be reduced as the pitches of the repetitive elements decrease. This facilitates discharge of the mud and the like clogged inside the grooves, and thus effectively improves the mud performance.

In a case where the circumferential groove 10 has a shape that does not include the widened portions 10A and the narrow width portions 10B (a straight shape or a zigzag shape with a constant groove width), mud and the like are not caught sufficiently, and the mud performance cannot be improved. In a case where the circumferential groove 10 includes the widened portions 10A and the narrow width portions 10B, which are randomly disposed, the widened portions 10A may not be included in the contact patch as the tire rotates, resulting in difficulty in constantly obtaining the effect of enhancing the mud performance by the widened portions 10A.

When the inclination angle θ of the imaginary straight line L does not satisfy the above-described relationship and increases as the pitches decrease, flows of mud in the angled inner grooves 11 are blocked, and mud and the like are easily clogged. This prevents the mud performance from being enhanced. The inclination angle θ of the imaginary straight line L may be set from 10° to 120°. In particular, the minimum value θmin of the inclination angle of the imaginary straight line L in one tire preferably ranges from 10° to 50° , more preferably, from 20° to 40°. The maximum value θmax preferably ranges from 40° to 120°, more preferably, from 60° to 100°. The difference Δθ between the minimum value θmin and the maximum value θmax preferably ranges from 30° to 90°. Setting the inclination angle in the above-described ranges facilitates the flows of mud and the like inside the grooves to improve the mud performance while enabling the noise to be effectively dispersed, thereby improving the noise performance. Consequently, these performances are advantageously provided in a compatible manner.

In a case where the minimum value θmin of the inclination angle of the imaginary straight line L is less than 10°, the opening positions of the pair of angled inner grooves 11 communicating with one widened portion 10A corresponding thereto are significantly shifted from each other in the tire circumferential direction. This causes the flows of mud and the like to be blocked, and prevents the mud performance from being sufficiently improved. In a case where the minimum value θmin of the inclination angle of the imaginary straight line L is greater than 50°, the difference between the minimum value θmin and the maximum value θmax is not sufficiently large, and the changes in the pitches of the repetitive elements become small. This prevents the frequencies of hitting sound from being sufficiently dispersed, and thus prevents the noise performance from being sufficiently improved. In a case where the maximum value θmax of the inclination angle of the imaginary straight line L is less than 40°, the difference between the minimum value θmin and the maximum value θmax is not sufficiently large, and the changes in the pitch of the repetitive elements become small. This prevents the frequencies of hitting sound from being sufficiently dispersed, and thus prevents the noise performance from being sufficiently improved. In a case where the minimum value θmin of the inclination angle of the imaginary straight line L is greater than 120°, the opening positions of the pair of angled inner grooves 11 communicating with one widened portion 10A corresponding thereto are significantly shifted from each other in the tire circumferential direction. This causes the flows of mud and the like to be blocked, and prevents the mud performance from being improved. In a case where the difference Δθ between the minimum value θmin and the maximum value θmax is less than 30°, the changes in the pitch of the repetitive elements are small. This prevents the frequencies of hitting sound from being sufficiently dispersed, and thus prevents the noise performance from being sufficiently improved. In a case where the difference Δθ between the minimum value θmin and the maximum value θmax is greater than 90°, the flows of mud and the like significantly vary for each widened portion 10A, thus, this prevents the mud performance from being improved.

In the present technology, as illustrated in FIG. 2, the repetitive elements disposed on one side of the circumferential groove 10 and the repetitive elements disposed on the other side of the circumferential groove 10 are preferably disposed such that the pitches of these repetitive elements are shifted from each other. Causing the pitches of the repetitive elements on both sides of the circumferential groove 10 to be shifted from each other as described above effectively reduces the fluctuations in ground reaction force to improve the driving performance and, at the same time, effectively disperses the noise to improve the noise performance.

In a case where the pitches of the repetitive elements on both sides of the circumferential groove 10 are shifted from each other as described above, each of the pair of angled inner grooves 11 communicating with one widened portion 10A corresponding thereto may be included in a repetitive element having a pitch different from that on either side of the circumferential groove 10. In this case, since the size relationship of the pitches is in proportion to the size relationship of the groove widths of the angled inner grooves 11, it is interpreted that the smaller the average values of the groove widths at the opening ends of the angled inner grooves 11 are, the smaller the pitches, and the inclination angle θ of the imaginary straight line L is reduced accordingly.

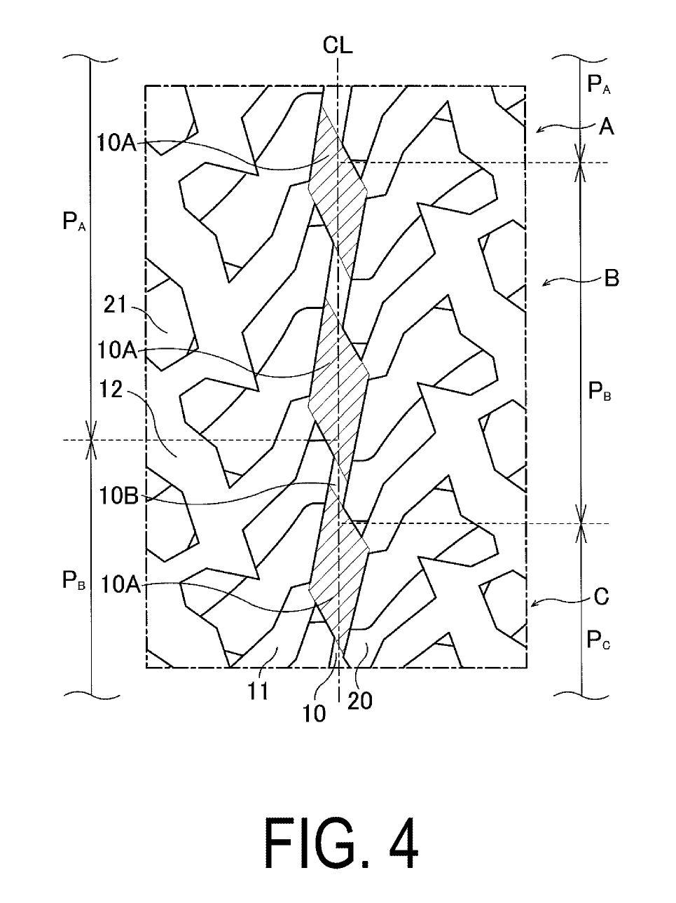

Although the widened portions 10A may have any shape with a groove width larger than the groove width of the narrow width portions 10B, in a case where the widened portions 10A have a substantially quadrangular shape including a pair of opposite angles protruding to both sides in the tire lateral direction (see hatched portions in the drawing) as illustrated in FIG. 4, for example, mud and the like flowing in the circumferential groove 10 are easily concentrated at parts around the opposite angles of the widened portions 10A. Thus, in addition to forming the widened portions 10A into a substantially quadrangular shape as described above, the angled inner grooves 11 are preferably made to communicate with the parts around the opposite angles of the widened portions 10A. Making the widened portions 10A communicate with the angled inner grooves 11 as described above enables the mud and the like, which are concentrated at the parts around the opposite angles of the widened portions 10A, to be efficiently discharged through the angled inner grooves 11, and thus advantageously enhances the mud performance.

### EXAMPLES

Eleven types of pneumatic tires according to Comparative Examples 1 to 4 and Examples 1 to 7 were manufactured. The tires had a tire size of LT265/70R17, a basic structure illustrated in FIG. 1, and a tread pattern having a basic design illustrated in FIG. 2. The presence of the widened portions and the narrow width portions, the communication position of the angled inner grooves, the presence of variation in the inclination angle, the minimum value θmin and the maximum value θmax of the inclination angle, the difference Δθbetween the maximum value and the minimum value, and the presence of pitch shift on either side of the circumferential groove were set as shown in Table 1.

“Communication position of angled inner groove” in Table 1 indicates that the angled inner grooves communicate with the narrow width portions or the widened portions of the circumferential groove and indicates that in a case where the angled inner grooves communicate with the widened portions, the angled inner grooves communicate with the parts around the opposite angles or side portions of the widened portions having a substantially quadrangular shape. The circumferential groove according to Comparative Example 1 did not include the widened portions and the narrow width portions and had an extended zigzag shape having a constant width. In the table, the box of the communication position of the angled inner grooves is empty since the angled inner grooves communicated with neither the widened portions nor the narrow width portions. “Change in inclination angle θ” in Table 1 indicates whether the inclination angle θ varied according to the pitches of the repetitive elements. It is indicated as “No” in a case where the inclination angle θ did not vary, “Yes” in a case where the inclination angle became smaller as the pitches of the repetitive elements decreased, and “Yes (inverse)” in a case where the inclination angle became larger as the pitches of the repetitive elements decreased.

These ten types of pneumatic tires were evaluated for mud performance and noise performance by the evaluation methods described below. The results are also shown in Table 1.

### Mud Performance

The test tires were assembled on wheels having a rim size of 17×8.0, inflated to an air pressure of 450 kPa, and mounted on a pickup truck (test vehicle). Sensory evaluation of traction performance and mud discharge performance was performed by a test driver on a muddy road surface. Evaluation results are expressed as index values, with Comparative Example 1 being assigned an index of 100. Larger index values indicate superior mud performance.

### Noise Performance

The test tires were assembled on wheels having a rim size of 17×8.0, inflated to an air pressure of 450 kPa, and mounted on a pickup truck (test vehicle). Sensory evaluation of cabin noise was performed while the vehicle is driven at a speed of 60 km/h. Evaluation results are expressed as index values, with Conventional Example 1 being assigned an index of 100. Larger index values indicate lower cabin noise and superior noise performance.

TABLE 1

| | Comparative | Comparative | Comparative | Comparative |
|---|---|---|---|---|
| | Example 1 | Example 2 | Example 3 | Example 4 |
| Presence of widened | No | Yes | Yes | Yes |
| portion and narrow | | | | |
| width portion | | | | |
| Communication position | — | Narrow width | Widened | Widened |
| of angled inner groove | | portion | portion | portion |
| | | | (Opposite | (Opposite |
| | | | angle) | angle) |
| Change in inclination | No | No | No | Yes (Inverse) |
| angle θ | | | | |
| Minimum value θmin | — | 60 | 60 | 75 |
| Maximum value θmax | — | 60 | 60 | 55 |
| Difference Δθ between ° | — | — | — | 20 |
| inclination angles | | | | |
| Pitch shift | No | No | No | Yes |
| Mud Index performance | 100 | 102 | 104 | 96 |
| Noise Index performance | 100 | 96 | 96 | 106 |

| | Example 1 | Example 2 | Example 3 | Example 4 | Example 5 | Example 6 | Example 7 |
|---|---|---|---|---|---|---|---|
| Presence of widened | Yes | Yes | Yes | Yes | Yes | Yes | Yes |
| portion and narrow | | | | | | | |
| width portion | | | | | | | |
| Communication position | Widened | Widened | Widened | Widened | Widened | Widened | Widened |
| of angled inner groove | portion | portion | portion | portion | portion | portion | portion |
| | (Opposite | (Opposite | (Opposite | (Opposite | (Opposite | (Opposite | (Side) |
| | angle) | angle) | angle) | angle) | angle) | angle) | |
| Change in inclination | Yes | Yes | Yes | Yes | Yes | Yes | Yes |
| angle θ | | | | | | | |
| Minimum value θmin | 55 | 30 | 30 | 30 | 10 | 30 | 30 |
| Maximum value θmax | 75 | 60 | 90 | 120 | 110 | 90 | 90 |
| Difference Δθ between ° | 20 | 30 | 60 | 90 | 100 | 60 | 60 |
| inclination angles | | | | | | | |
| Pitch shift | Yes | Yes | Yes | Yes | Yes | No | Yes |
| Mud Index performance | 104 | 106 | 110 | 108 | 106 | 110 | 104 |
| Noise Index performance | 106 | 108 | 110 | 110 | 107 | 103 | 106 |

As is clear from Table 1, the mud performance and the noise performance in Examples 1 to 7 were enhanced in a well-balanced, compatible manner in comparison with Comparative Example 1. On the other hand, in Comparative Example 2, although the circumferential groove included both the widened portions and the narrow width portions, the angled inner grooves communicated with the narrow width portions, and the inclination angle θ was constant. As a result, the mud performance was not sufficiently improved. Additionally, the noise performance was not improved. In Comparative Example 3, although the circumferential groove included both the widened portions and the narrow width portions and the angled inner grooves communicated with the widened portions, the inclination angle θ was constant. As a result, the mud performance was not sufficiently improved. Additionally, the noise performance was not improved. In Comparative Example 4, the circumferential groove included both the widened portions and the narrow width portions, the angled inner grooves communicated with the widened portions, and the inclination angle θ varied. However, since the inclination angle θ increased as the pitches of the repetitive elements decreased, the mud discharge capability was impaired more, resulting in degraded mud performance.

1. A pneumatic tire, comprising a circumferential groove extending in a tire circumferential direction in a center region of a tread portion, a plurality of angled inner grooves disposed on either side of the circumferential groove and communicating with the circumferential groove while being inclined in one direction with respect to the tire circumferential direction, a plurality of angled outer grooves disposed on either side of the circumferential groove and communicating with the angled inner grooves while being inclined in another direction with respect to the tire circumferential direction, center blocks defined by the grooves at positions adjacent to the circumferential groove, and shoulder blocks defined by the grooves between the angled outer grooves adjacent to each other in the tire circumferential direction, the pneumatic tire further comprising a plurality of repetitive elements including the grooves and the blocks and repeatedly disposed in the tire circumferential direction, the repetitive elements including a plurality of repetitive elements of plurality of types having different pitches, wherein
the circumferential groove includes a plurality of widened portions and a plurality of narrow width portions alternately disposed in the tire circumferential direction and thus has a groove width varying in the tire circumferential direction,
the angled inner grooves communicate with the widened portions, and
an inclination angle θ, formed by an imaginary straight line connecting centers of opening ends of a pair of the angled inner grooves open to and communicating with the widened portion corresponding thereto, with respect to the tire circumferential direction, varies for each widened portion and decreases as the pitches of the repetitive elements decrease.

2. The pneumatic tire according to claim 1, wherein a minimum value θmin of the inclination angle is from 10° to 50°, a maximum value θmax of the inclination angle is from 40° to 120°, and a difference Δθ between the minimum value θmin and the maximum value θmax is from 30° to 90°.

3. The pneumatic tire according to claim 1, wherein the repetitive elements disposed on one side of the circumferential groove and the repetitive elements disposed on an other side of the circumferential groove are disposed such that the pitches of the repetitive elements are shifted from each other.

4. The pneumatic tire according to claim 1, wherein the widened portions have a substantially quadrangular shape including a pair of opposite angles protruding to both sides in a tire lateral direction, and the angled inner grooves communicate with the widened portions at parts around the opposite angles.

5. The pneumatic tire according to claim 2, wherein the repetitive elements disposed on one side of the circumferential groove and the repetitive elements disposed on an other side of the circumferential groove are disposed such that the pitches of the repetitive elements are shifted from each other.

6. The pneumatic tire according to claim 5, wherein the widened portions have a substantially quadrangular shape including a pair of opposite angles protruding to both sides in a tire lateral direction, and the angled inner grooves communicate with the widened portions at parts around the opposite angles.
